(19) United States
(12) Patent Application Publication
(10) Pub. No.: US 2026/0333319 A1
(43) Pub. Date: Oct. 22, 2026

(54) METHOD FOR KEEPING CARRIER, DEVICE AND STORAGE MEDIUM

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/105,699

(22) PCT Filed: Aug. 24, 2022
(86) PCT No.: PCT/CN2022/114565

§ 371 Date: Feb. 21, 2025

(51) Int. Cl. H04W 72/0453; H04W 24/08; H04W 36/30; H04W 72/542

(52) U.S. Cl. CPC H04W 72/0453; H04W 24/08; H04W 36/30; H04W 72/542

(57) ABSTRACT

A method for keeping a carrier, including: a terminal device obtaining a keeping threshold value configured by a network device for keeping the carrier; determining at least one first resource pool corresponding to a current operating carrier of the terminal device in a case where the terminal device triggers carrier reselection, wherein the at least one first resource pool is a resource pool comprising a candidate resource available for reselection over the current operating carrier; and determining, based on a channel busy ratio (CBR) measurement result for the at least one first resource pool, whether the terminal device needs to reselect the current operating carrier.

### CROSS-REFERENCE TO RELATED APPLICATIONS

The present application is a U.S. National Stage of International Application No. PCT/CN2022/114565, filed on Aug. 24, 2022, the contents of all of which are incorporated herein by reference in their entireties for all purposes.

### BACKGROUND OF THE INVENTION

In a communication system, in order to support direct communication between terminal devices and improve efficiency of communication, Sidelink and Carrier Aggregation (CA) are introduced, where a resource allocation mode of Sidelink is that a network dynamically schedules resources or the terminal devices independently select resources in a resource pool for network broadcasting. Moreover, the CA technology is also introduced into a communication system, so as to effectively increase uplink and downlink transmission rates.

### SUMMARY OF THE INVENTION

The present disclosure relates to the technical field of communication, and provides a method for keeping a carrier, a device, and a storage medium.

In a first aspect, an embodiment of the present disclosure provides a method for keeping a carrier, which is performed by a terminal device and includes: obtaining a keeping threshold value configured by a network device for keeping the carrier; determining at least one first resource pool corresponding to a current operating carrier of the terminal device in a case where the terminal device triggers carrier reselection, where the at least one first resource pool is a resource pool including a candidate resource available for reselection on the current operating carrier; and determining, based on a channel busy ratio (CBR) measurement result for the at least one first resource pool, whether the terminal device needs to reselect the current operating carrier.

In a second aspect, an embodiment of the present disclosure provides a method for keeping a carrier, which is performed by a network device and includes: configuring a keeping threshold value for keeping the carrier for a terminal device.

In a third aspect, an embodiment of the present disclosure provides a communication device, which includes one or more processors and a memory, where the memory stores a computer program; and the one or more processors are collectively configured to execute the computer program stored in the memory to cause the communication device to: obtain a keeping threshold value configured by a network device for keeping a carrier; determine at least one first resource pool corresponding to a current operating carrier of the terminal device in a case where the terminal device triggers carrier reselection, wherein the at least one first resource pool is a resource pool comprising a candidate resource available for reselection over the current operating carrier; and determine, based on a channel busy ratio (CBR) measurement result for the at least one first resource pool, whether the terminal device needs to reselect the current operating carrier.

In a fourth aspect, an embodiment of the present disclosure provides a communication device, which includes one or more processors and a memory, where the memory stores a computer program; and the one or more processors are collectively configured to execute the computer program stored in the memory to cause the communication device to perform the method according to the second aspect.

In a fifth aspect, an embodiment of the present disclosure provides a communication device, which includes one or more processors and an interface circuit, where the interface circuit is configured to receive code instructions and transmit the code instructions to the one or more processors, and the one or more processors are collectively configured to run the code instructions to cause the communication device to perform the method according to the first aspect.

In a sixth aspect, an embodiment of the present disclosure provides a communication device, which includes one or more processors and an interface circuit, where the interface circuit is configured to receive code instructions and transmit the code instructions to the one or more processors, and the one or more processors are collectively configured to run the code instructions to cause the communication device to perform the method according to the second aspect.

In a seventh aspect, an embodiment of the present disclosure provides a non-transitory computer-readable storage medium, which is configured to store one or more computer programs, configured to be collectively executed by one or more processors of the aforementioned terminal device, the one or more programs comprising instructions used by the terminal device, where the instructions, when executed, cause the terminal device to perform the method according to the first aspect mentioned.

In an eighth aspect, an embodiment of the present disclosure provides a non-transitory computer-readable storage medium, which is configured to store one or more computer programs, configured to be collectively executed by one or more processors of the aforementioned network device, the one or more programs comprising instructions used by the network device, where the instructions, when executed, cause the network device to perform the method according to the first aspect mentioned.

### BRIEF DESCRIPTION OF DRAWINGS

The aforementioned and/or additional aspects and advantages of the present disclosure will become apparent and easily understood from the following description of the embodiments with reference to the accompanying drawings.

FIG. 1 is a schematic architecture diagram of a communication system according to an embodiment of the present disclosure.

FIG. 2 is a schematic flowchart of a method for keeping a carrier according to an embodiment of the present disclosure.

FIG. 3A is a schematic flowchart of a method for keeping a carrier according to another embodiment of the present disclosure.

FIG. 3B is a schematic flowchart of a method for keeping a carrier according to another embodiment of the present disclosure.

FIG. 4A is a schematic flowchart of a method for keeping a carrier according to another embodiment of the present disclosure.

FIG. 4B is a schematic flowchart of a method for keeping a carrier according to another embodiment of the present disclosure.

FIG. 5A is a schematic flowchart of a method for keeping a carrier according to another embodiment of the present disclosure.

FIG. 5B is a schematic flowchart of a method for keeping a carrier according to another embodiment of the present disclosure.

FIG. 6A is a schematic flowchart of a method for keeping a carrier according to another embodiment of the present disclosure.

FIG. 6B is a schematic flowchart of a method for keeping a carrier according to another embodiment of the present disclosure.

FIG. 7 is a schematic flowchart of a method for keeping a carrier according to another embodiment of the present disclosure.

FIG. 8 is a schematic flowchart of a method for keeping a carrier according to another embodiment of the present disclosure.

FIG. 9 is a schematic structural diagram of a communication device according to an embodiment of the present disclosure.

FIG. 10 is a schematic structural diagram of a communication device according to another embodiment of the present disclosure.

FIG. 11 is a block diagram of a terminal device according to an embodiment of the present disclosure.

FIG. 12 is a block diagram of a network-side device according to an embodiment of the present disclosure.

### DETAILED DESCRIPTION OF THE INVENTION

Reference will now be made in detail to the examples, examples of which are illustrated in the accompanying drawings. The following description refers to the accompanying drawings in which the same numbers in the different accompanying drawings represent the same or similar elements, unless otherwise indicated. The implementations described in the following examples do not represent all implementations consistent with the embodiments of the present disclosure. Rather, they are merely examples of units and methods consistent with certain aspects of the embodiments of the present disclosure, as detailed in the appended claims.

The terms used in the embodiments of the present disclosure are merely intended for describing the specific embodiments rather than limiting the embodiments of the present disclosure. The singular forms, “a/an” and “this”, used in the embodiments and claims of the present disclosure are also intended to include plural forms, unless other meanings are clearly indicated in contexts. It will also be understood that the term “and/or” used herein refers to and includes any or all possible combinations of one or more associated listed items.

It will be understood that although terms like first, second and third may be adopted in the embodiments of the present disclosure to describe various information, the information is limited to such terms. Such terms are merely used to differentiate the same type of information from one another. For example, without departing from the scope of the embodiments of the present disclosure, first information may also be called second information, and likewise, the second information may also be called the first information. Depending on the context, the word “if” used herein may be interpreted as “when” or “in response to determining”.

The embodiments of the present disclosure will be described in detail below, and the examples of the embodiments are shown in the accompanying drawings, throughout which same or similar reference numerals represent same or similar elements. The embodiments described below with reference to the accompanying drawings are exemplary and are intended to explain the present disclosure rather than be construed as limiting the present disclosure.

In order to facilitate understanding, the terms involved in the present application are first introduced.

### 1. Sidelink (SL)

Sidelink communication is divided into two modes, one is called discovery between terminal devices, and the other is called communication between the terminal devices. Sidelink uses uplink resources and uplink physical channels similar to a cellular network (LTE) for interactive data transmission.

### 2. Channel Busy Ratio (CBR)

CBR is a parameter to measure an occupation of sub-channels in a frequency band. Terminal devices perform CBR measurement in a transmission resource pool according to network-side configurations. The lower a CBR value is, the fewer the terminal devices occupy the sub-channels of the resource pool to transmit data, and the less collision is when the resource pool is selected for data transmission.

### 3. Carrier Aggregation (CA)

A plurality of component carriers (CC) may be aggregated together to achieve a higher transmission bandwidth, so as to effectively increase uplink and downlink transmission rates, and therefore, a terminal device may determine how many carriers may be simultaneously used at most for uplink and downlink transmission according to its own capacity.

In the related art, both Long Term Evolution Vehicle to Everything (LTE V2X) and New Radio (NR) Sidelink can support the Sidelink and CA technologies, where in terms of the mode of independently selecting the resources, the terminal devices in both an LTE V2X system and an NR Sidelink system can select and reselect carriers. Moreover, when reselecting a carrier, a terminal device will specifically judge whether to reselect a current operating carrier. One carrier in the LTE V2X system supports configuration of one resource pool, and the terminal device can determine whether to reselect the current operating carrier based on comparison between a measured channel busy ratio (CBR) of the resource pool configured corresponding to a certain carrier and a keeping threshold value.

However, in the related art, in the NR Sidelink system, one carrier can support the configuration of a plurality of resource pools, where one CBR will be measured corresponding to one resource pool, so that the one carrier will correspond to a plurality of CBRs. At this point, when whether to reselect the current operating carrier is determined, it is impossible to determine which CBR corresponding to one resource pool of the current operating carrier should be specifically used to compare with the keeping threshold value, resulting in the terminal device in the NR Sidelink system being unable to judge whether to reselect the current operating carrier.

In order to better understand an indication method disclosed by an embodiment of the present disclosure, a communication system to which the embodiments of the present disclosure are applicable will be described first.

The embodiments of the present disclosure will be described in detail below, and the examples of the embodiments are shown in the accompanying drawings, throughout which same or similar reference numerals represent same or similar elements. The embodiments described below with reference to the accompanying drawings are exemplary and are intended to explain the present disclosure rather than be construed as limiting the present disclosure.

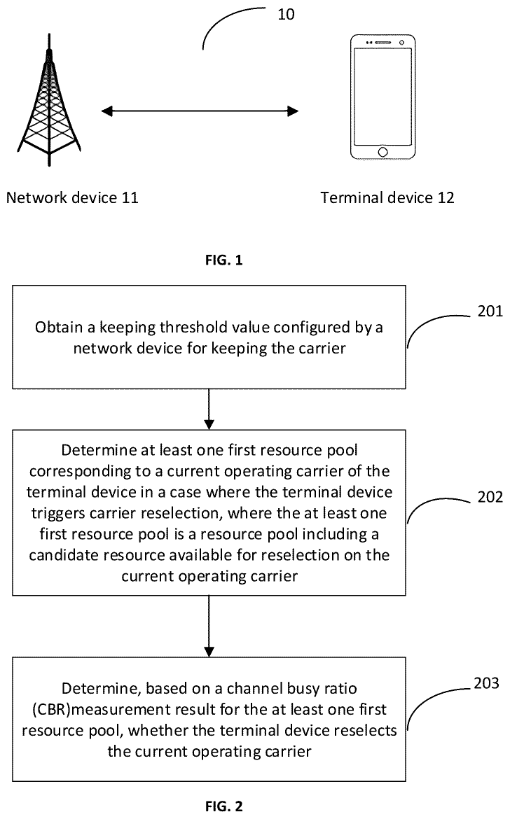

Referring to FIG. 1, FIG. 1 is a schematic architecture diagram of a communication system 10 according to an embodiment of the present disclosure. The communication system 10 may include, but is not limited to, a network device 11 and a terminal device 12. A number and forms of the devices shown in FIG. 1 are only shown as an example, and do not constitute a limitation to the embodiments of the present disclosure. In practical application, two or more network devices and two or more terminal devices may be included. The communication system 10 shown in FIG. 1 includes one network device 11 and one terminal device 12 as an example.

It should be noted that the technical solution of the embodiment of the present disclosure may be applied to various communication systems, e.g., long term evolution (LTE) systems, 5th generation (5G) mobile communication systems, 5G new radio (NR) systems, or other novel mobile communication systems in the future.

The network device 11 in the embodiment of the present disclosure is a network-side entity for transmitting or receiving signals. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system. The embodiment of the present disclosure does not limit a specific technology and a specific device form adopted by the network device 11. The network device 11 according to the embodiment of the present disclosure may be composed of a central unit (CU) and distributed units (DUs), where the CU may also be referred to as a control unit. By adopting a CU-DU structure, protocol layers of the network device 11, such as the base station, may be split, functions of some of the protocol layers being centrally controlled by the CU, and functions of some or all of the remaining protocol layers being distributed in the DUs, and the DUs are centrally controlled by the CU.

The terminal device 12 in the embodiment of the present disclosure is a user-side entity for receiving or transmitting signals, such as a mobile phone. The terminal device 12 may also be called a terminal, user equipment (UE), a mobile station (MS), a mobile terminal (MT), etc. The terminal device 12 may be a car with a communication function, an intelligent car, a mobile phone, a wearable device, a pad, a computer with a wireless transceiving function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home, etc. The embodiment of the present disclosure does not limit a specific technology and a specific device form adopted by the terminal device 12.

FIG. 2 is a schematic flowchart of a method for keeping a carrier according to an embodiment of the present disclosure, which is performed by a terminal device. As shown in FIG. 2, the method for keeping the carrier may include the following steps 201-203.

At Step 201, a keeping threshold value configured by a network device for keeping the carrier is obtained.

The method of the present disclosure may be applied to an NR Sidelink system.

In one embodiment of the present disclosure, the keeping threshold value may be used as a criterion to determine whether to keep (or reselect) a current operating carrier. How to specifically determine whether to keep (or reselect) the current operating carrier according to the keeping threshold value will be described in detail in the following embodiment.

Moreover, in one embodiment of the present disclosure, the step of “a keeping threshold value configured by a network device for keeping the carrier is obtained” may include at least one of the following steps: a keeping threshold value configured by the network device for each cell (i.e., different keeping threshold values corresponding to different cells) is obtained; a keeping threshold value configured by the network device for each BWP (i.e., different keeping threshold values corresponding to different BWPs) is obtained; a keeping threshold value configured by the network device for each frequency (i.e., different keeping threshold values corresponding to different frequencies) is obtained; a keeping threshold value configured by the network device for the terminal device is obtained, where the keeping threshold value corresponding to the terminal device and keeping threshold values corresponding to other terminal devices are separately configured by the network device (i.e., different keeping threshold values corresponding to different terminal devices); or a keeping threshold value configured by the network device for each logical channel priority (i.e., different keeping threshold values corresponding to different cells) is obtained.

It should be noted that in one embodiment of the present disclosure, the aforementioned different granularities may also be combined in pairs, in threes, in fours, and so on. For example, taking the combination of the aforementioned different granularities in pairs as an example, assuming a combination of “each cell” and “each logical channel priority”, at this point, the terminal device will obtain the keeping threshold value configured by the network device for each logical channel priority of each cell, where the different logical channels priorities of different cells correspond to different configured keeping threshold values. For example, a configured keeping threshold value of a first priority of the logical channel in cell #1 is A, and a configured keeping threshold value of a first priority of the logical channel in cell #2 is B.

Moreover, in one embodiment of the present disclosure, the aforementioned keeping threshold value may be configured by the network device through dedicated Ratio Resource Control (RRC) signaling and/or a System Information Block (SIB). In another embodiment of the present disclosure, the aforementioned keeping threshold value may also be preconfigured.

At Step 202, at least one first resource pool corresponding to the current operating carrier of the terminal device is determined in a case where the terminal device triggers carrier reselection, where the at least one first resource pool is a resource pool including a candidate resource available for reselection on the current operating carrier.

In one embodiment of the present disclosure, the carrier reselection may be triggered by a Hybrid Automatic Retransmission Request (HARQ) process or a logical channel.

Moreover, in one embodiment of the present disclosure, the aforementioned resource pool may be specifically pre-configured by the network device, where one carrier may be configured with at least one resource pool, which includes resources for Sidelink transmission (such as time frequency resources), transmission-related parameters, etc., and frequency domain resources in the resource pool may be divided by sub-channels. A size of the sub-channel in the resource pool may be 10, 15, 20, 25, 50, 75 or 100 (Physical Resource Block (PRB)), and the sub-channel may be a physical channel.

Moreover, in one embodiment of the present disclosure, after the carrier reselection is triggered, the terminal device will generally determine the candidate resource available for reselection, so as to reselect the candidate resource for communication later. The candidate resource may belong to the source resource pool or other resource pools.

Further, in one embodiment of the present disclosure, after the carrier reselection is triggered and the candidate resource is determined, the terminal device will determine at least one first resource pool corresponding to the current operating carrier based on the candidate resource. The first resource pool is specifically a resource pool including the candidate resource available for reselection on the current operating carrier, so that whether to reselect the current operating carrier can be determined later based on a CBR measurement result for the first resource pool.

In one embodiment of the present disclosure, carrier reselection may refer to cell reselection, i.e., reselection between different cells using different carriers. In addition, the operating carrier may refer to a carrier used by communication between the terminal device and its serving cell.

At Step 203, based on a CBR measurement result for the at least one first resource pool, whether the terminal device needs to reselect the current operating carrier is determined.

In one embodiment of the present disclosure, a CBR measurement result for a resource pool is specifically a CBR measurement value, which may be used to reflect an occupation of sub-channels in the resource pool. The lower the CBR measurement result is, the fewer terminal devices occupy the sub-channels of the resource pool, and the less collision is when the resource pool is reselected for data transmission; and the higher the CBR measurement result is, the more sub-channels are used for data transmission in the resource pool, and the higher collision is when the resource pool is reselected for data transmission.

It should be noted that, in one embodiment of the present disclosure, the CBR measurement result for the aforementioned resource pool may be calculated by a Physics (PHY) layer/Media Access Control (MAC) layer. Moreover, in a V2X system, for a Physical Sidelink Shared Channel (PSSCH), a CBR of the resource pool may be a proportion of sub-channels with sidelink received signal strength indicators (S-RSSIs) exceeding a threshold of −94 dBm in the resource pool. For a PSCCH with non-adjacent control and data resources, the CBR of the resource pool may be a proportion of resources (two PRB pairs) with the S-RSSIs exceeding the threshold of −94 dBm in the resource pool.

Moreover, a specific implementation on how to determine, based on the CBR measurement result for the first resource pool, whether the terminal device needs to reselect the current operating carrier in the aforementioned step will be described in detail in the subsequent embodiments.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is the resource pool including the candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting the configuration of the plurality of resource pools”. That is, the method according to the present disclosure can be performed by the terminal device of the NR Sidelink system to judge whether to reselect the current operating carrier.

In addition, it should be noted that the terminal device may currently use a plurality of resource pools, so it may occur that some of the plurality of currently-used resource pools simultaneously trigger resource (or carrier) reselection processes. Based on this, for the resource (or carrier) reselection process corresponding to each resource pool, whether the current operating carrier can be kept can be judged by performing the method provided by the present disclosure.

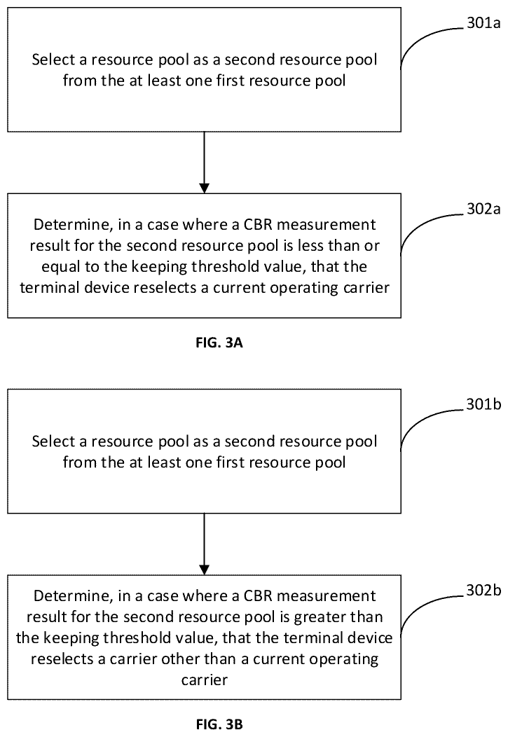

FIG. 3A is a schematic flowchart of a method for keeping a carrier according to an embodiment of the present disclosure, which is performed by a terminal device. As shown in FIG. 3A, the method for keeping the carrier may include the following steps 301a-302a.

At Step 301a, a resource pool is selected as a second resource pool from the at least one first resource pool.

When there are a plurality of first resource pools, in one embodiment of the present disclosure, the terminal device may randomly select one resource pool as the second resource pool from the plurality of first resource pools. In another embodiment of the present disclosure, the terminal device may select the resource pool with a minimum CBR measurement result as the second resource pool from the plurality of first resource pools. In yet another embodiment of the present disclosure, the terminal device may also select the resource pool with a maximum CBR measurement result as the second resource pool from the plurality of first resource pools.

At Step 302a, determine, in a case where a CBR measurement result for the second resource pool is less than or equal to the keeping threshold value, that the terminal device reselects the current operating carrier.

In one embodiment of the present disclosure, when the CBR measurement result for the second resource pool is less than or equal to the keeping threshold value, it means that the CBR measurement result for the second resource pool is low, that is, few sub-channels are used for data transmission in the second resource pool, and at this point, the possibility of collision is low if the second resource pool is reselected for data transmission. Therefore, it is determined that the second resource pool is eligible for reselection. Further, since the second resource pool is configured on the current operating carrier, it can be determined that the current operating carrier is also eligible for reselection. At this point, it can be determined that the terminal device reselects the current carrier (i.e., continuing to keep on the current operating carrier), without reselecting other carriers, so that unnecessary reselection steps can be reduced, improving efficiency of communication.

Moreover, it should be noted that in one embodiment of the present disclosure, if the keeping threshold value is configured in a different way, the CBR measurement result for the second resource pool will also be compared with the keeping threshold value in a different way at Step 302a. Specifically, in one embodiment of the present disclosure, if the keeping threshold value is configured for each cell, each BWP, each frequency or the terminal device, at Step 302a, the CBR measurement result for the second resource pool is specifically compared with the keeping threshold value corresponding to the second resource pool.

For example, in one embodiment of the present disclosure, if the keeping threshold value is set for each cell, specifically, when the CBR measurement result for the second resource pool is less than or equal to the keeping threshold value corresponding to the cell to which the second resource pool belongs, it is determined that the terminal device reselects the current operating carrier. Alternatively, if the keeping threshold value is set for each BWP, specifically, when the CBR measurement result for the second resource pool is less than or equal to the keeping threshold value corresponding to the BWP to which the second resource pool belongs, it is determined that the terminal device reselects the current operating carrier.

In another embodiment of the present disclosure, in a case where the keeping threshold value is configured for each logical channel priority, the CBR measurement result for the second resource pool is compared with the keeping threshold value corresponding to each logical channel priority having to-be-transmitted data and triggering carrier reselection.

For example, assuming that keeping threshold values are configured for different logical channels priorities, respectively, and that the logical channels priorities include a first priority, a second priority, and a third priority, the keeping threshold values configured for the first priority, the second priority and the third priority are keeping threshold value #1, keeping threshold value #2 and keeping threshold value #3, respectively. At this point, if carrier reselection is triggered by logical channel #1 and logical channel #2, and both logical channel #1 and logical channel #2 have to-be-transmitted data, the priority of logical channel #1 is the first priority, the priority of logical channel #2 is the second priority, and the priority of logical channel #3 is the third priority. Then, specifically, when the CBR measurement result for the second resource pool is less than or equal to CBR threshold value #1 corresponding to the first priority of logical channel #1 having the to-be-transmitted data and triggering carrier reselection, and less than or equal to CBR threshold value #2 corresponding to the second priority of logical channel #2 having the to-be-transmitted data and triggering carrier reselection, it is determined that the terminal device reselects the current operating carrier.

In yet another embodiment of the present disclosure, if keeping threshold values are configured for the different logical channels priorities in different cells, respectively, specifically, the CBR measurement result for the second resource pool is compared with a resource pool with the CBR threshold value corresponding to each logical channel priority having the to-be-transmitted data and triggering carrier reselection in the cell to which the second resource pool belongs.

For example, assuming that keeping threshold values are configured for the different logical channels priorities in different cells, respectively, the logical channels priorities include a first priority, a second priority and a third priority, the keeping threshold values configured for the first priority, the second priority and the third priority of the logical channels in cell #1 are keeping threshold value #1, keeping threshold value #2 and keeping threshold value #3, respectively, and the keeping threshold values configured for the first priority, the second priority and the third priority of the logical channels in cell #2 are keeping threshold value #4, keeping threshold value #5 and keeping threshold value #6, respectively. At this point, if the carrier of cell #2 is the current operating carrier of the terminal device, and the second resource pool is one resource pool on the current operating carrier, assuming that logical channel #1 and logical channel #2 in cell #2 trigger carrier reselection and logical channel #1, logical channel #2 and logical channel #3 in cell #2 all have the to-be-transmitted data, the priority of logical channel #1 is the first priority, the priority of logical channel #2 is the second priority, and the priority of logical channel #3 is the third priority. At this point, when the CBR measurement result for the second resource pool is less than or equal to keeping threshold value #4 corresponding to the first priority of logical channel #1 having the to-be-transmitted data and triggering carrier reselection in cell #2 and less than or equal to keeping threshold value #5 corresponding to the second priority of logical channel #2 having the to-be-transmitted data and triggering carrier reselection in cell #2, it is determined that the terminal device reselects the current operating carrier.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is a resource pool including candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

FIG. 3B is a schematic flowchart of a method for keeping a carrier according to an embodiment of the present disclosure, which is performed by a terminal device. As shown in FIG. 3B, the method for keeping the carrier may include the following steps 301b-302b.

At Step 301b, a resource pool is selected as a second resource pool from the at least one first resource pool.

For the related introduction of Step 301b, refer to the description of the aforementioned embodiments.

At Step 302b, determine, in a case where a CBR measurement result for the second resource pool is greater than the keeping threshold value, that the terminal device reselects a carrier other than the current operating carrier.

In one embodiment of the present disclosure, when the CBR measurement result for the second resource pool is greater than the keeping threshold value, it means that the CBR measurement result for the second resource pool is high, that is, many sub-channels are used for data transmission in the second resource pool, and at this point, the possibility of collision is high if the second resource pool is reselected for data transmission. Therefore, it is determined that the second resource pool is not eligible for reselection. Further, since the second resource pool is configured on the current operating carrier, it can be determined that the current operating carrier is also not eligible for reselection. At this point, the terminal device should reselect other carriers with low possibility of collision, so as to avoid communication collision and ensure communication stability.

Moreover, in one embodiment of the present disclosure, for the way in which the CBR measurement result for the second resource pool is compared with the keeping threshold value at Step 302b, refer to the description the aforementioned embodiments.

In addition, it should be noted that referring to the corresponding embodiments in FIGS. 3A and 3B, there is a special case. That is, when the CBR measurement result for the second resource pool is equal to the keeping threshold value, the terminal device can reselect the current operating carrier or a carrier other than the current operating carrier. At this point, whether the terminal device reselects the current operating carrier or a carrier other than the current operating carrier may be autonomously determined at random based on implementation of the terminal device.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is a resource pool including candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

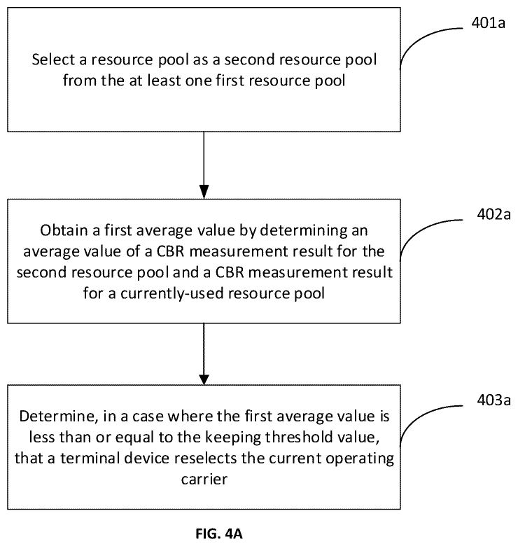

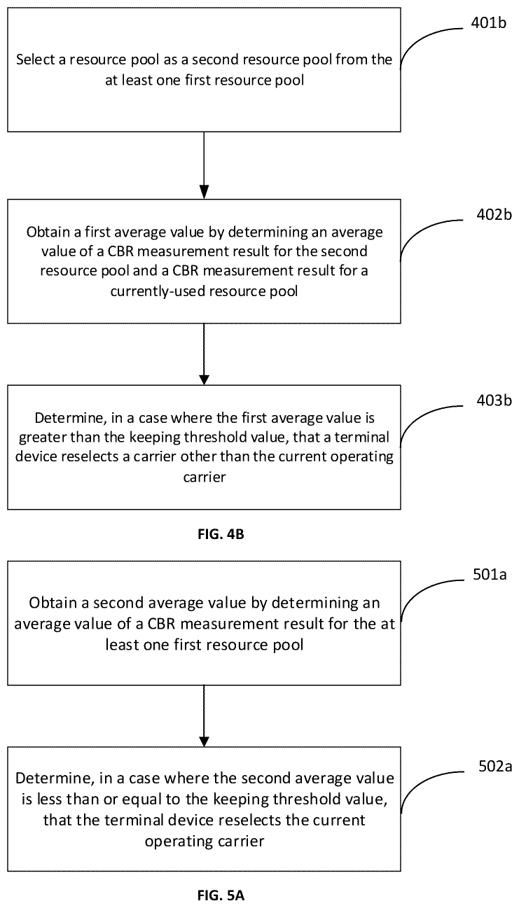

FIG. 4A is a schematic flowchart of a method for keeping a carrier according to an embodiment of the present disclosure, which is performed by a terminal device. As shown in FIG. 4A, the method for keeping the carrier may include the following steps 401a-403a.

At Step 401a, a resource pool is selected as a second resource pool from the at least one first resource pool.

For the detailed introduction of Step 401a, refer to the description of the aforementioned embodiments.

At Step 402a, a first average value is obtained by determining an average value of a CBR measurement result for the second resource pool and a CBR measurement result for a currently-used resource pool.

It should be noted that the second resource pool and the currently-used resource pool are both resource pools configured on the current operating carrier. Moreover, the second resource pool and the currently-used resource pool belong to a same activated BWP.

At Step 403a, determine, in a case where the first average value is less than or equal to the keeping threshold value, that the terminal device reselects the current operating carrier.

In one embodiment of the present disclosure, when the first average value is less than or equal to the keeping threshold value, it means that an average number of sub-channels for data transmission in the second resource pool and the currently-used resource pool is small, and at this point, the possibility of collision is low if the second resource pool or the currently-used resource pool is reselected for data transmission. Therefore, it is determined that the second resource pool and the currently-used resource pool are eligible for reselection. Further, since the second resource pool and the currently-used resource pool are configured on the current operating carrier, it can be determined that the current operating carrier is also eligible for reselection. At this point, it can be determined that the terminal device reselects the current carrier (i.e., continuing to stay on the current operating carrier), without reselecting other carriers, so that unnecessary reselection steps can be reduced, improving the efficiency of communication.

In addition, for the other related introductions of Step 403a, refer to the description of the aforementioned embodiments.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is a resource pool including a candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

FIG. 4B is a schematic flowchart of a method for keeping a carrier according to an embodiment of the present disclosure, which is performed by a terminal device. As shown in FIG. 4B, the method for keeping the carrier may include the following steps 401b-403b.

At Step 401b, a resource pool is selected as a second resource pool from the at least one first resource pool.

At Step 402b, a first average value is obtained by determining an average value of a CBR measurement result for the second resource pool and a CBR measurement result for a currently-used resource pool.

At Step 403b, determine, in a case where the first average value is greater than the keeping threshold value, that the terminal device reselects a carrier other than the current operating carrier.

In one embodiment of the present disclosure, when the first average value is greater than the keeping threshold value, it means that an average number of sub-channels for data transmission in the second resource pool and the currently-used resource pool is large, and at this point, the possibility of collision is high if the second resource pool or the currently-used resource pool is reselected for data transmission. Therefore, it is determined that the second resource pool and the currently-used resource pool are not eligible for reselection. Further, since the second resource pool and the currently-used resource pool are configured on the current operating carrier, it can be determined that the current operating carrier is also not eligible for reselection. At this point, the terminal device should reselect other carriers with low possibility of collision, so as to avoid communication collision and ensure communication stability.

For the related introduction of Steps 401b to 403b, refer to the description of the aforementioned embodiments.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is a resource pool including a candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

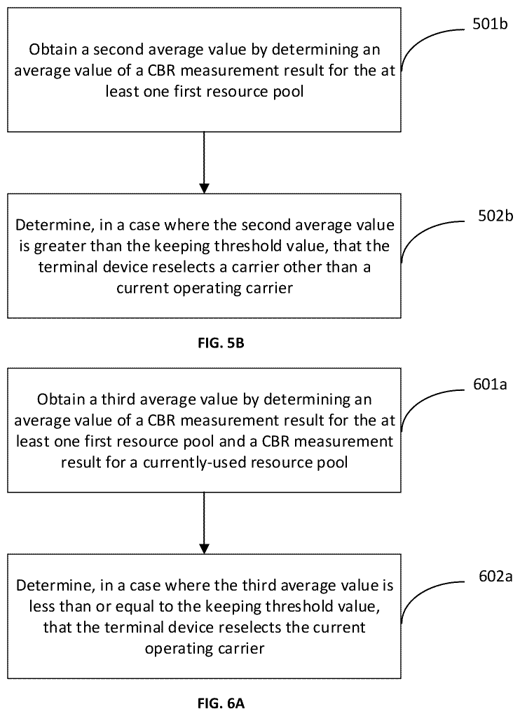

FIG. 5A is a schematic flowchart of a method for keeping a carrier according to an embodiment of the present disclosure, which is performed by a terminal device. As shown in FIG. 5A, the method for keeping the carrier may include the following steps 501a-502a.

At Step 501a, a second average value is obtained by determining an average value of a CBR measurement result for the at least one first resource pool.

In one embodiment of the present disclosure, each first resource pool is a resource pool configured on the current operating carrier. Moreover, each first resource pool belongs to a same activated BWP.

At Step 502a, determine, in a case where the second average value is less than or equal to the keeping threshold value, that the terminal device reselects the current operating carrier.

In one embodiment of the present disclosure, when the second average value is less than or equal to the keeping threshold value, it means that an average number of sub-channels for data transmission in the at least one first resource pool is small, and at this point, the possibility of collision is low if any first resource pool is reselected for data transmission. Therefore, it is determined that the first resource pool is eligible for reselection. Further, since the first resource pool is configured on the current operating carrier, it can be determined that the current operating carrier is also eligible for reselection. At this point, it can be determined that the terminal device reselects the current carrier (i.e., continuing to keep on the current operating carrier), without reselecting other carriers, so that unnecessary reselection steps can be reduced, improving efficiency of communication.

For the related introduction of Steps 501a and 502a, refer to the description of the aforementioned embodiments.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is a resource pool including a candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

FIG. 5B is a schematic flowchart of a method for keeping a carrier according to an embodiment of the present disclosure, which is performed by a terminal device. As shown in FIG. 5B, the method for keeping the carrier may include the following steps 501b-502b.

At Step 501b, a second average value is obtained by determining an average value of a CBR measurement result for the at least one first resource pool.

At Step 502b, determine, in a case where the second average value is greater than the keeping threshold value, that the terminal device reselects a carrier other than the current operating carrier.

In one embodiment of the present disclosure, when the second average value is greater than the keeping threshold value, it means that an average number of sub-channels for data transmission in the at least one first resource pool is large, and at this point, the possibility of collision is high if any first resource pool is reselected for data transmission. Therefore, it is determined that the first resource pool is not eligible for reselection. Further, since the first resource pool is configured on the current operating carrier, it can be determined that the current operating carrier is also not eligible for reselection. At this point, the terminal device should reselect other carriers with low possibility of collision, so as to avoid communication collision and ensure communication stability.

For the related introduction of Steps 501b and 502b, refer to the description of the aforementioned embodiments.

To sum up, in the method for keeping a carrier provided by the embodiment of the present disclosure, the terminal device first obtains the keeping threshold value configured by the network device for keeping the carrier; then, in a case where the terminal device triggers carrier reselection, the at least one first resource pool corresponding to the current operating carrier of the terminal device is determined, where the first resource pool is a resource pool including a candidate resource available for reselection on the current operating carrier; and finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

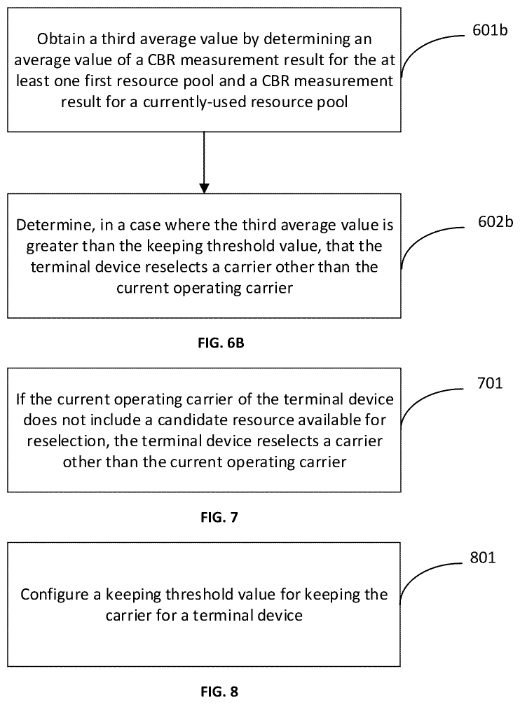

FIG. 6A is a schematic flowchart of a method for keeping a carrier according to an embodiment of the present disclosure, which is performed by a terminal device. As shown in FIG. 6A, the keeping the carrier method may include the following steps 601a-602a.

At Step 601a, a third average value is obtained by determining an average value of a CBR measurement result for the at least one first resource pool and a CBR measurement result for a currently-used resource pool.

At Step 602a, determine, in a case where the third average value is less than or equal to the keeping threshold value, that the terminal device reselects the current operating carrier.

For the related introduction of Steps 601a and 602a, refer to the description of the aforementioned embodiments.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is a resource pool including a candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

FIG. 6B is a schematic flowchart of a method for keeping a carrier according to an embodiment of the present disclosure, which is performed by a terminal device. As shown in FIG. 6B, the method for keeping the carrier may include the following steps 601b-602b.

At Step 601b, a third average value is obtained by determining an average value of a CBR measurement result for the at least one first resource pool and a CBR measurement result for a currently-used resource pool.

At Step 602b, determine, in a case where the third average value is greater than the keeping threshold value, that the terminal device reselects a carrier other than the current operating carrier.

For the related introduction of Steps 601b and 602b, refer to the description of the aforementioned embodiments.

To sum up, in the method for keeping a carrier provided by the embodiment of the present disclosure, the terminal device first obtains the keeping threshold value configured by the network device for keeping the carrier. Then, in a case where the terminal device triggers carrier reselection, the at least one first resource pool corresponding to the current operating carrier of the terminal device is determined, where the first resource pool is a resource pool including a candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

FIG. 7 is a schematic flowchart of a method for keeping a carrier according to an embodiment of the present disclosure, which is performed by a terminal device. As shown in FIG. 7, the method for keeping the carrier may include the following step 701.

At Step 701, if the current operating carrier of the terminal device does not include a candidate resource available for reselection, the terminal device reselects a carrier other than the current operating carrier.

In one embodiment of the present disclosure, when the current operating carrier of the terminal device does not include the candidate resource available for reselection, it means that the current operating carrier is not eligible for reselection, and at this point, the terminal device should reselect other carriers with low possibility of collision, so as to avoid communication collision and ensure communication stability.

To sum up, in the method for keeping a carrier provided by the embodiment of the present disclosure, the terminal device first obtains a keeping threshold value configured by the network device for keeping the carrier. Then, in a case where the terminal device triggers carrier reselection, at least one first resource pool corresponding to the current operating carrier of the terminal device is determined, where the first resource pool is a resource pool including a candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting the configuration of the plurality of resource pools”. That is, the method according to the present disclosure can be performed by the terminal device of the NR Sidelink system to judge whether to reselect the current operating carrier.

FIG. 8 is a schematic flowchart of a method for keeping a carrier according to an embodiment of the present disclosure, which is performed by a network device. As shown in FIG. 8, the method for keeping the carrier may include the following step 801.

At Step 801, a keeping threshold value for keeping the carrier is configured for a terminal device.

In one embodiment of the present disclosure, the step of “a keeping threshold value for keeping the carrier is configured for the terminal device” may include at least one of the following steps: a keeping threshold value corresponding to each cell is configured for the terminal device; a keeping threshold value corresponding to each BWP is configured for the terminal device; a keeping threshold value corresponding to each frequency is configured for the terminal device; a keeping threshold value corresponding to the terminal device is configured for the terminal device, where the network device configures corresponding keeping threshold values for the terminal device and other terminal devices separately; or a keeping threshold value corresponding to each logical channel priority is configured for the terminal device.

For the other related introductions of Step 801, refer to the description of the aforementioned embodiments.

To sum up, in the method for keeping a carrier provided by the embodiment of the present disclosure, the terminal device first obtains the keeping threshold value configured by the network device for keeping the carrier. Then, in a case where the terminal device triggers carrier reselection, at least one first resource pool corresponding to a current operating carrier of the terminal device is determined, where the first resource pool is a resource pool including a candidate resource available for reselection on the current operating carrier. Finally, based on a CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

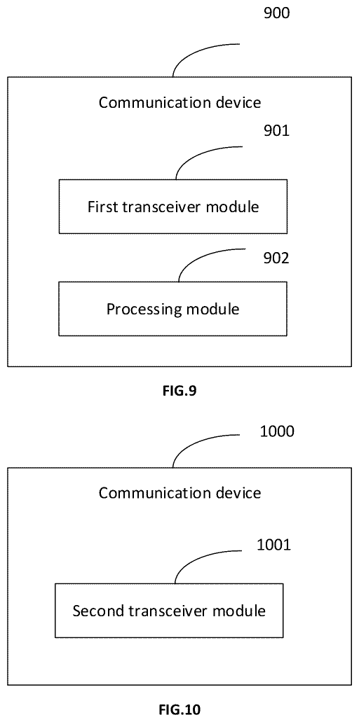

FIG. 9 is a schematic structural diagram of a communication device 900 according to an embodiment of the present disclosure. As shown in FIG. 9, the communication device 900 may include a first transceiver module 901 and a processing module 902.

The first transceiver module 901 is configured to obtain a keeping threshold value configured by a network device for keeping a carrier.

The processing module 902 is configured to determine at least one first resource pool corresponding to a current operating carrier of the terminal device in a case where the terminal device triggers carrier reselection, where the at least one first resource pool is a resource pool including a candidate resource available for reselection on the current operating carrier. The processing module 902 is further configured to determine, based on a CBR measurement result for the at least one first resource pool, whether the terminal device needs to reselect the current operating carrier.

To sum up, in the communication device 900 provided by the embodiment of the present disclosure, the terminal device first obtains the keeping threshold value configured by the network device for keeping a carrier. Then, in a case where the terminal device triggers carrier reselection, the at least one first resource pool corresponding to the current operating carrier of the terminal device is determined, where the first resource pool is the resource pool including the candidate resource available for reselection on the current operating carrier. Finally, based on the CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

Optionally, in one embodiment of the present disclosure, the first transceiver module 901 configured to perform at least one of the following steps: obtaining a keeping threshold value configured by the network device for each cell; obtaining a keeping threshold value configured by the network device for each BWP; obtaining a keeping threshold value configured by the network device for each frequency; obtaining a keeping threshold value configured by the network device for the terminal device, where the keeping threshold value corresponding to the terminal device and keeping threshold values corresponding to other terminal devices are separately configured by the network device; or obtaining a keeping threshold value configured by the network device for each logical channel priority.

Optionally, in one embodiment of the present disclosure, the processing module 902 is further configured to: select a resource pool as a second resource pool from the at least one first resource pool; and determine, in a case where a CBR measurement result for the second resource pool is less than or equal to the keeping threshold value, that the terminal device reselects the current operating carrier; or determine, in a case where the CBR measurement result for the second resource pool is greater than the keeping threshold value, that the terminal device reselects a carrier other than the current operating carrier.

Optionally, in one embodiment of the present disclosure, the processing module 902 is further configured to: select a resource pool as a second resource pool from the at least one first resource pool; obtaining a first average value by determine an average value of a CBR measurement result for the second resource pool and a CBR measurement result for a currently-used resource pool; and determine, in a case where the first average value is less than or equal to the keeping threshold value, that the terminal device reselects the current operating carrier; or determine, in a case where the first average value is greater than the keeping threshold value, that the terminal device reselects a carrier other than the current operating carrier.

Optionally, in one embodiment of the present disclosure, the processing module 902 is further configured to: select a resource pool with a minimum CBR measurement result from the at least one first resource pool as the second resource pool; select a resource pool with a maximum CBR measurement result from the at least one first resource pool as the second resource pool; or randomly select a resource pool from the at least one first resource pool as the second resource pool.

Optionally, in one embodiment of the present disclosure, the processing module 902 is further configured to: obtaining a second average value by determine an average value of the CBR measurement result for the at least one first resource pool to obtain a second average value; and determine, in a case where the second average value is less than or equal to the keeping threshold value, that the terminal device reselects the current operating carrier; or determine, in a case where the second average value is greater than the keeping threshold value, that the terminal device reselects a carrier other than the current operating carrier.

Optionally, in one embodiment of the present disclosure, the processing module 902 is further configured to: obtaining a third average value by determining an average value of the CBR measurement result for the at least one first resource pool and a CBR measurement result for a currently-used resource pool; and determining, in a case where the third average value is less than or equal to the keeping threshold value, that the terminal device reselects the current operating carrier; or determining, in a case where the third average value is greater than the keeping threshold value, that the terminal device reselects a carrier other than the current operating carrier.

Optionally, in one embodiment of the present disclosure, the processing module 902 is further configured to: determine, in a case where the keeping threshold value is configured for each cell, each BWP, each frequency or the terminal device and the CBR measurement result for the second resource pool, the first average value, the second average value or the third average value is less than or equal to a respective keeping threshold value, that the terminal device reselects the current operating carrier; or determine, in a case where the keeping threshold value is configured for each cell, each BWP, each frequency or the terminal device and the CBR measurement result for the second resource pool, the first average value, the second average value or the third average value is greater than the respective keeping threshold value, that the terminal device reselects a carrier other than the current operating carrier.

Optionally, in one embodiment of the present disclosure, the processing module 902 is further configured to: determine, in a case where the keeping threshold value is configured for each logical channel priority and the CBR measurement result for the second resource pool, the first average value, the second average value or the third average value is less than or equal to a keeping threshold value corresponding to each logical channel priority having to-be-transmitted data and triggering carrier reselection, that the terminal device reselects the current operating carrier; or determine, in a case where the keeping threshold value is configured for each logical channel priority and the CBR measurement result for the second resource pool, the first average value, the second average value or the third average value is greater than the keeping threshold value corresponding to each logical channel priority having the to-be-transmitted data and triggering carrier reselection, that the terminal device reselects a carrier other than the current operating carrier.

Optionally, in one embodiment of the present disclosure, the communication device 900 is further configured to: reselect, by the terminal device, in a case where the current operating carrier of the terminal device does not comprise the candidate resource available for reselection, a carrier other than the current operating carrier.

FIG. 10 is a schematic structural diagram of a communication device 1000 according to an embodiment of the present disclosure. As shown in FIG. 10, the communication device 1000 may include a second transceiver module 1001.

The second transceiver module 1001 is configured to configure a keeping threshold value for keeping a carrier for a terminal device.

To sum up, in the communication device 1000 provided by the embodiment of the present disclosure, the terminal device first obtains the keeping threshold value configured by the network device for keeping a carrier. Then, in a case where the terminal device triggers carrier reselection, at least one first resource pool corresponding to the current operating carrier of the terminal device is determined, where the first resource pool is a resource pool including a candidate resource available for reselection on a current operating carrier. Finally, based on a CBR measurement result for the first resource pool, whether the terminal device needs to reselect the current operating carrier is determined. It can be known from this that in the present disclosure, in a case where the current operating carrier is configured with a plurality of resource pools, the terminal device can determine whether to reselect the current operating carrier based on the CBR measurement result for the at least one first resource pool including the candidate resource available for reselection corresponding to the current operating carrier, so the method according to the present disclosure can be applied to a case of “one carrier supporting configuration of the plurality of resource pools”. That is, the method according to the present disclosure can be performed by the terminal device of the NR Sidelink system to judge whether to reselect the current operating carrier.

Optionally, in one embodiment of the present disclosure, the second transceiver module 1001 configured to perform at least one of the following steps: a keeping threshold value corresponding to each cell is configured for the terminal device; a keeping threshold value corresponding to each BWP is configured for the terminal device; a keeping threshold value corresponding to each frequency is configured for the terminal device; a keeping threshold value corresponding to the terminal device is configured for the terminal device, where the network device configures corresponding keeping threshold values for the terminal device and other terminal devices separately; or a keeping threshold value corresponding to each logical channel priority is configured for the terminal device.

Referring to FIG. 11, FIG. 11 is a schematic structural diagram of a communication device 1100 according to an embodiment of the present application. The communication device 1100 may be a network device; a terminal device; a chip, a chip system or a processor which supports the network device to implement the aforementioned methods; or a chip, a chip system or a processor which supports the terminal device to implement the aforementioned methods. The communication device 1100 may be used to implement the methods described in the aforementioned method embodiments. For details, refer to the descriptions in the aforementioned method embodiments.

The communication device 1100 may include one or more first processors 1101. The first processor 1101 may be a general-purpose processor or a special-purpose processor. For example, the processor may be a baseband processor or a central processing unit. The baseband processor may be configured to process communication protocols and communication data, and the central processor can be configured to control the communication device (such as a base station, a baseband chip, a terminal device, a terminal device chips, a DU or a CU), executing a computer program, and processing data of the computer program.

Optionally, the communication device 1100 may further include one or more first memories 1102 in which a second computer program 1104 may be stored. The first processor 1101 can execute the second computer program 1104, so that the communication device 1100 can execute the methods described in the aforementioned method embodiments. Optionally, data may also be stored in the first memory 1102. The communication device 1100 and the first memory 1102 may be arranged separately or integrated together.

Optionally, the communication device 1100 may further include a transceiver 1105 and an antenna 1106. The transceiver 1105 may be called a transceiver unit, a transceiver device, or a transceiver circuit, and is configured to implement a transceiving function. The transceiver 1105 may include a receiver 1108 and a transmitter 1109. The receiver 1108 may be called a receiving device or a receiving circuit, and is configured to implement a receiving function. The transmitter 1109 may be called a transmitting device or a transmitting circuit, and is configured to implement a transmitting function.

Optionally, the communication device 1100 may further include one or more interface circuits 1107. The interface circuit 1107 is configured to receive code instructions and transmit the code instructions to the first processor 1101. The first processor 1101 can run the code instructions, so that the communication device 1100 can execute the methods described in the aforementioned method embodiments.

In one implementation, the first processor 1101 may include a transceiver (not shown) for implementing receiving and transmitting functions. For example, the transceiver can be a transceiver circuit, an interface, or an interface circuit. Transceiver circuits, interfaces or interface circuits for implementing receiving and transmitting functions may be separated or integrated together. The aforementioned transceiver circuit, interface or interface circuit may be configured to read and writing codes/data, or the aforementioned transceiver circuit, interface or interface circuit may be configured for signal transmission or transfer.

In one implementation, the first processor 1101 may store a first computer program 1103. When running on the first processor 1101, the first computer program 1103 can enable the communication device 1100 to execute the methods described in the aforementioned method embodiments. The first computer program 1103 may be burnt in the first processor 1101, and in this case, the first processor 1101 may be implemented by hardware.

In one implementation, the communication device 1100 may include a circuit (not shown), which may implement a transmitting, receiving or communication function in the aforementioned method embodiments. The first processor 1101 and the transceiver 1105 described in the present application may be implemented on an integrated circuit (IC), an analog IC, a radio frequency integrated circuit (RFIC), a mixed-signal IC, an application specific integrated circuit (ASIC), a printed circuit board (PCB), an electronic device, etc. The first processor 1101 and the transceiver 1105 may also be manufactured by various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device 1100 described in the aforementioned embodiment may be a network device or a terminal device, but the scope of the communication device described in the present application is not limited to this, and a structure of the communication device may not be limited by FIG. 11. The communication device may be a self-contained device or part of a larger device. For example, the communication device may be: (1) an independent IC, a chip, a chip system, or a subsystem; (2) a set with one or more ICs (optionally, the IC set may further include a storage component for storing data and a computer program); (3) the ASIC (e.g., a modem); (4) a module capable of being embedded in other devices; (5) the receiver, the terminal device, an intelligent terminal device, a cellular phone, a wireless device, a handset, a mobile unit, a vehicle-mounted device, a network device, a cloud device, an artificial intelligence device, or so on; or (6) others and so on.

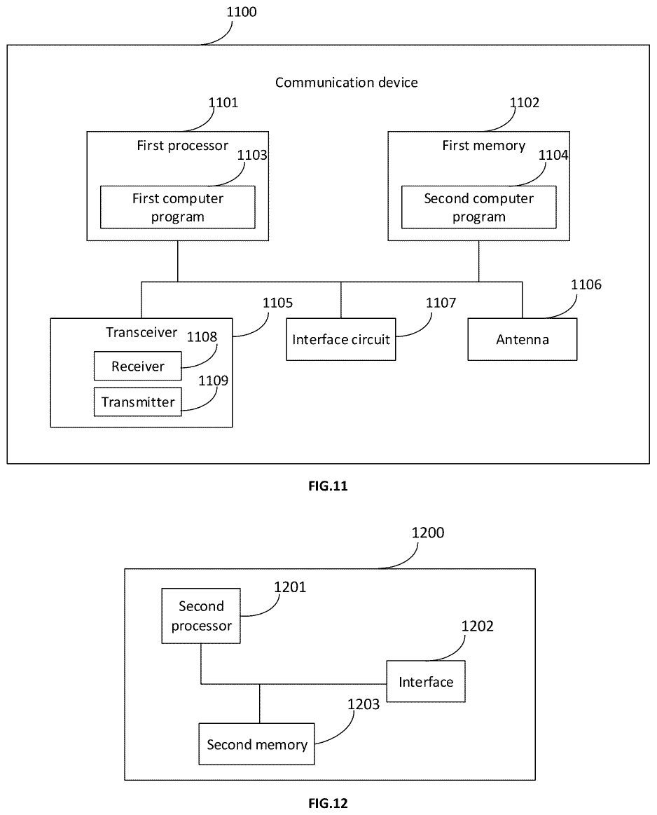

For the case that the communication device may be the chip or the chip system, refer to the schematic structural diagram of the chip 1200 shown in FIG. 12. The chip 1200 shown in FIG. 12 includes a second processor 1201 and an interface 1202. There may be one or more second processors 1201, and there may be a plurality of interfaces 1202.

Optionally, and as shown in FIG. 12, the chip 1200 further includes a second memory 1203, which is configured to store a necessary computer program and data.

Those skilled in the art can also understand that various illustrative logical blocks and steps listed in the embodiments of the present application may be implemented by electronic hardware, computer software, or a combination of both. Whether such functions are implemented by hardware or software depends on a specific application and the design requirements of the whole system. Those skilled in the art can use various methods to implement the described functions for each specific application, but such implementation should not be understood as going beyond the protection scope of the embodiments of the present application.

The present application further provides a non-transitory computer-readable storage medium in which instructions are stored. When the instructions are executed by a computer, the function of any of the aforementioned method embodiments is implemented.

The present application further provides a computer program product. When the computer program product is executed by a computer, the function of any of the aforementioned method embodiments is implemented.

All or part of the aforementioned embodiments may be implemented by the software, the hardware, firmware, or any combination thereof. When implemented by the software, all or part of the aforementioned embodiments may be implemented in a form of the computer program product. The computer program product includes one or more computer programs. When the computer program is loaded and executed on the computer, all or part of the flows or functions according to the embodiments of the present application are generated. The computer may be a general-purpose computer, a special-purpose computer, a computer network, or other programmable devices. The computer program may be stored in a non-transitory computer-readable storage medium or transmitted from one non-transitory computer-readable storage medium to another non-transitory computer-readable storage medium. For example, the computer program may be transmitted from a website, computer, server or data center to another website, computer or data center in a wired (e.g., a coaxial cable, an optical fiber, or a digital subscriber line (DSL)) or wireless (e.g., infrared, radio or microwave) way. The non-transitory computer-readable storage medium may be any available medium which a computer can access, or a data storage device (such as a server or a data center) in which one or more available media are integrated. The available medium may be a magnetic medium (e.g., a floppy disk, a hard disk, or a magnetic tape), an optical medium (e.g., a high-density digital video disc (DVD)), or a semiconductor medium (e.g., a solid state disk (SSD)).

As used herein, the term processor may refer to one processor that performs the defined functions or a plurality of processors that collectively perform defined functions, so that the execution of the individual defined functions may be divided amongst such processors.

It can be understood by those of ordinary skill in the art that various numerical numbers (such as “first” and “second”) involved in the present application are merely intended for distinguishment to facilitate description rather than intended to limit the scope of the embodiments of the present application, and also indicate an order.

“At least one” in the present application may also be described as “one or more”, and “a plurality of” may be two, three, four or more, and this is not limited by the present application. In the embodiments of the present application, for a technical feature, the technical features in the technical feature are distinguished by “first”, “second”, “third”, “A”, “B”, “C” and “D”, and there is no order or size order between the technical features described by the “first”, “second”, “third”, “A”, “B”, “C” and “D”.

The corresponding relationships shown in each table in the present application may be configured or predefined. Values of information in each table are merely examples, and the information may be configured as other values, which is not limited by the present application. When a corresponding relationship between the information and each parameter is configured, it is not necessary to configure all the corresponding relationships indicated in each table. For example, in one table in the present application, the corresponding relationships shown in some rows may not be configured. For another example, appropriate transformation (e.g., splitting and merging) may be made based on the aforementioned table. Names of parameters shown by headers in each table mentioned may also be other names which can be understood by the communication device, and values or representations of the parameters may also be other values or representations which can be understood by the communication device. When the aforementioned tables are implemented, other data structures may also be adopted, such as arrays, queues, containers, stacks, linear lists, pointers, linked lists, trees, graphs, structs, classes, heaps, or hash tables.

“Predefined” in the present application may be understood as “defined”, “predefined”, “stored”, “pre-stored”, “pre-negotiated”, “pre-configured”, “burnt”, or “pre-burnt”.

Those of ordinary skill in the art can realize that units and algorithm steps of each example described in conjunction with the embodiments disclosed herein can be implemented by electronic hardware or a combination of computer software and the electronic hardware. Whether these functions are implemented by the hardware or the software may depend on specific applications and design constraints of the technical solution. Those skilled in the art can use different methods for each specific application to implement the described functions, but this implementation should not be considered as going beyond the scope of the present application.

It can be clearly understood by those skilled in the art that for convenience and simplicity of description, the specific operating process of the system, the device and the units described may refer to the corresponding processes in the foregoing method embodiments, which will not be repeated here.

What is described is merely the specific embodiments of the present application. However, the protection scope of the present application is not limited to this. Any person skilled in the art can easily think of variations or substitutions within the technical scope disclosed in the present application, and these variations or substitutions shall fall within the protection scope of the present application. Therefore, the protection scope of the present application shall be subject to the protection scope of the claims.

1. A method for keeping a carrier, performed by a terminal device, and the method comprising:
obtaining a keeping threshold value configured by a network device for keeping the carrier;
determining at least one first resource pool corresponding to a current operating carrier of the terminal device in a case where the terminal device triggers carrier reselection, wherein the at least one first resource pool is a resource pool comprising a candidate resource available for reselection over the current operating carrier; and
determining, based on a channel busy ratio (CBR) measurement result for the at least one first resource pool, whether the terminal device reselects the current operating carrier.

2. The method according to claim 1, wherein obtaining the keeping threshold value configured by the network device for keeping the carrier comprises at least one of:
obtaining the keeping threshold value configured by the network device for at least one cell;
obtaining the keeping threshold value configured by the network device for at least one bandwidth part (BWP);
obtaining the keeping threshold value configured by the network device for at least one frequency;
obtaining the keeping threshold value configured by the network device for the terminal device, wherein the keeping threshold value corresponding to the terminal device and keeping threshold values corresponding to other terminal devices are separately configured by the network device; or
obtaining the keeping threshold value configured by the network device for at least one logical channel priority.

3. The method according to claim 2, wherein determining, based on the CBR measurement result for the at least one first resource pool, whether the terminal device reselects the current operating carrier comprises:
selecting a resource pool as a second resource pool from the at least one first resource pool; and
determining, in a case where a CBR measurement result for the second resource pool is less than or equal to the keeping threshold value, that the terminal device reselects the current operating carrier, or
determining, in a case where the CBR measurement result for the second resource pool is greater than the keeping threshold value, that the terminal device reselects a carrier other than the current operating carrier.

4. The method according to claim 2, wherein determining, based on the CBR measurement result for the at least one first resource pool, whether the terminal device reselects the current operating carrier comprises:
selecting a resource pool as a second resource pool from the at least one first resource pool;
obtaining a first average value by determining an average value of a CBR measurement result for the second resource pool and a CBR measurement result for a currently-used resource pool; and
determining, in a case where the first average value is less than or equal to the keeping threshold value, that the terminal device reselects the current operating carrier, or
determining, in a case where the first average value is greater than the keeping threshold value, that the terminal device reselects a carrier other than the current operating carrier.

5. The method according to claim 3, wherein selecting the resource pool as the second resource pool from the at least one first resource pool comprises one of:
selecting a resource pool with a minimum CBR measurement result from the at least one first resource pool as the second resource pool;
selecting a resource pool with a maximum CBR measurement result from the at least one first resource pool as the second resource pool; or
selecting any one resource pool from the at least one first resource pool as the second resource pool.

6. The method according to claim 2, wherein determining, based on the CBR measurement result for the at least one first resource pool, whether the terminal device reselects the current operating carrier comprises:
obtaining a second average value by determining an average value of the CBR measurement result for the at least one first resource pool; and
determining, in a case where the second average value is less than or equal to the keeping threshold value, that the terminal device reselects the current operating carrier, or
determining, in a case where the second average value is greater than the keeping threshold value, that the terminal device reselects a carrier other than the current operating carrier.

7. The method according to claim 2, wherein determining, based on the CBR measurement result for the at least one first resource pool, whether the terminal device reselects the current operating carrier comprises:
obtaining a third average value by determining an average value of the CBR measurement result for the at least one first resource pool and a CBR measurement result for a currently-used resource pool; and
determining, in a case where the third average value is less than or equal to the keeping threshold value, that the terminal device reselects the current operating carrier, or
determining, in a case where the third average value is greater than the keeping threshold value, that the terminal device reselects a carrier other than the current operating carrier.

8. The method according to claim 2, wherein:
determining, in a case where the keeping threshold value is configured for the at least one cell, the at least one BWP, the at least one frequency or the terminal device and the CBR measurement result for a second resource pool, a first average value, a second average value or a third average value is less than or equal to a respective keeping threshold value, that the terminal device reselects the current operating carrier; or
determining, in a case where the keeping threshold value is configured for the at least one cell, the at least one BWP, the at least one frequency or the terminal device and the CBR measurement result for the second resource pool, the first average value, the second average value or the third average value is greater than the respective keeping threshold value, that the terminal device reselects a carrier other than the current operating carrier, and
wherein the second resource pool is a resource pool selected from the at least one first resource pool, the first average value is an average value of a CBR measurement result for the second resource pool and a CBR measurement result for a currently-used resource pool, the second average value is an average value of the CBR measurement result for the at least one first resource pool, and the third average value is an average value of the CBR measurement result for the at least one first resource pool and the CBR measurement result for the currently-used resource pool.

9. The method according to claim 2, wherein:
determining, in a case where the keeping threshold value is configured for the at least one logical channel priority and the CBR measurement result for a second resource pool, a first average value, a second average value or a third average value is less than or equal to a keeping threshold value corresponding to the at least one logical channel priority having to-be-transmitted data and triggering the carrier reselection, that the terminal device reselects the current operating carrier; or
determining, in a case where the keeping threshold value is configured for the at least one logical channel priority and the CBR measurement result for the second resource pool, the first average value, the second average value or the third average value is greater than the keeping threshold value corresponding to the at least one logical channel priority having the to-be-transmitted data and triggering the carrier reselection, that the terminal device reselects a carrier other than the current operating carrier, and
wherein the second resource pool is a resource pool selected from the at least one first resource pool, the first average value is an average value of a CBR measurement result for the second resource pool and a CBR measurement result for a currently-used resource pool, the second average value is an average value of the CBR measurement result for the at least one first resource pool, and the third average value is an average value of the CBR measurement result for the at least one first resource pool and the CBR measurement result for the currently-used resource pool.

10. The method according to claim 1, further comprising:
reselecting, by the terminal device, in a case where the current operating carrier of the terminal device does not comprise the candidate resource available for reselection, a carrier other than the current operating carrier.

11. A method for keeping a carrier, performed by a network device, and the method comprising:
configuring a keeping threshold value for keeping the carrier for a terminal device.

12. The method according to claim 11, wherein configuring the keeping threshold value for keeping the carrier for the terminal device comprises at least one of:
configuring the keeping threshold value corresponding to at least one cell for the terminal device;
configuring the keeping threshold value corresponding to at least one BWP for the terminal device;
configuring the keeping threshold value corresponding to at least one frequency for the terminal device;
configuring the keeping threshold value corresponding to the terminal device for the terminal device, wherein the network device configures corresponding keeping threshold values for the terminal device and other terminal devices separately; or
configuring the keeping threshold value corresponding to at least one logical channel priority for the terminal device.

13.-14. (canceled)

15. A communication device, comprising:
one or more processors; and
a memory storing a computer program, and
wherein the one or more processors are collectively configured to execute the computer program stored in the memory to cause the communication device to:
obtain a keeping threshold value configured by a network device for keeping a carrier,
determine at least one first resource pool corresponding to a current operating carrier of the terminal device in a case where the terminal device triggers carrier reselection, wherein the at least one first resource pool is a resource pool comprising a candidate resource available for reselection over the current operating carrier, and
determine, based on a channel busy ratio (CBR) measurement result for the at least one first resource pool, whether the terminal device reselects the current operating carrier.

16. A communication device, comprising:
one or more processors; and
an interface circuit configured to receive code instructions and transmit the code instructions to the one or more processors, and
wherein the one or more processors are collectively configured to run the code instructions to perform the method according to claim 1.

17. A non-transitory computer-readable storage medium storing one or more computer programs, configured to be collectively executed by one or more processors of a terminal device, the one or more programs comprising instructions used by the terminal device, wherein the instructions, when executed, cause the terminal device to implement the method according to claim 1.

18. A communication device, comprising:
one or more processors; and
a memory, wherein the memory stores a computer program, and
wherein the one or more processors are collectively configured to execute the computer program to cause the communication device to perform the method according to claim 11.

19. A communication device, comprising:
one or more processors; and
an interface circuit configured to receive code instructions and transmit the code instructions to the one or more processors, and
wherein the one or more processors are collectively configured to run the code instructions to perform the method according to claim 11.

20. A non-transitory computer-readable storage medium storing one or more computer programs, configured to be collectively executed by one or more processors of a network device, the one or more programs comprising instructions used by the network device, wherein the instructions, when executed, cause the network device to implement the method according to claim 11.

21. The method according to claim 4, wherein selecting the resource pool as the second resource pool from the at least one first resource pool comprises one of:
selecting a resource pool with a minimum CBR measurement result from the at least one first resource pool as the second resource pool;
selecting a resource pool with a maximum CBR measurement result from the at least one first resource pool as the second resource pool; or
selecting any one resource pool from the at least one first resource pool as the second resource pool.
